(19) United States
(12) Patent Application Publication
(10) Pub. No.: US 2011/0292221 A1
(43) Pub. Date: Dec. 1, 2011

(54) AUTOMATIC CAMERA

(75) Inventors: Ye Gu, Bellevue, WA (US); Johnny Liu, Shanghai (CN); Sridhar Srinivasan, Shanghai (CN)

(73) Assignee: Micorsoft Corporation, Redmond, WA (US)

(21) Appl. No.: 12/787,413

(22) Filed: May 26, 2010

(51) Int. Cl. H04N 5/225

(52) U.S. Cl. 348/207.1; 348/E05.024

(57) ABSTRACT

Architecture that employs a “trainer” camera which uses various pieces of information about the scene being photographed in order to provide the user with options for improving the quality of the photo. The user is guided to emulate professionally or highly rated photographs of the same scene and in the process is trained by the camera to take better pictures. As cameras come equipped with sensory functions such as geolocation capabilities, compass, altimeter, and wireless connectivity such as cellular, Wi-Fi, and Bluetooth, the architecture assists the consumer to take higher quality photos by leveraging these new capabilities as well as the vast amount of photo data and information stored on the Internet and other locations.

### BACKGROUND

Experience is a distinguishing characteristic between an amateur and a professional photographer. Professionals know which part of a given scene to put into the image frame, what lighting is best for desired effect, how to focus the shot, what aperture, shutter, and “film” (ISO-international organization of standardization) speeds to use-all before a shot is taken. Amateurs mostly just aim and shoot and hope for the best. They don't have the experience to guide them for better shots or the time and patience to try getting a better shot. In some ways, digital cameras have made it easier for people to shoot pictures carelessly since the cost of taking a picture is virtually zero. Unfortunately they usually only find out the poor picture quality afterwards. This could be a real loss especially if they were taken at places where people would visit only once in a life time.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs a “trainer” camera that uses various pieces of information about the scene being photographed in order to provide the user with options for improving the quality of the photo. The user is guided to emulate professionally or highly rated photographs of the same scene and in the process is trained by the camera to take better pictures.

As cameras come equipped with sensory functions such as geolocation capabilities (e.g., GPS (global positioning system)), compass, altimeter, and wireless connectivity such as cellular, Wi-Fi, and Bluetooth, the architecture assists the consumer to take higher quality photos by leveraging these new capabilities. Moreover, the vast amount of photo data and information stored on the Internet and other areas can be further employed to assist the consumer setting up shots including aim and focus on the key part of a scene and camera settings such as aperture, shutter speed, ISO, etc. Thus, amateur photographers can now capture photos with the quality otherwise associated with professional photographers.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a photographic system in accordance with the disclosed architecture.

FIG. 2 illustrates a system where a camera employs an orientation component to determine and track heading and an angular offset from a plane of view to the scene.

FIG. 3 illustrates a computer-implemented photographic method in accordance with the disclosed architecture.

FIG. 4 illustrates further aspects of the method of FIG. 3.

FIG. 5 illustrates a block diagram of a computing system that can interface to the camera in accordance with the disclosed architecture.

### DETAILED DESCRIPTION

The disclosed architecture assists the user in taking better pictures by leveraging these capabilities of existing and new technology cameras by accessing vast amounts of photo (image) data and camera data stored “in the cloud” (the Internet). For example, the architecture assists the user in setting up shots, including aim and focus, on the key part(s) of a scene, and camera settings such as aperture, shutter speed, ISO, etc. Thus, amateur photographers are now able to capture images of scenes using quality similar professional photographers.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

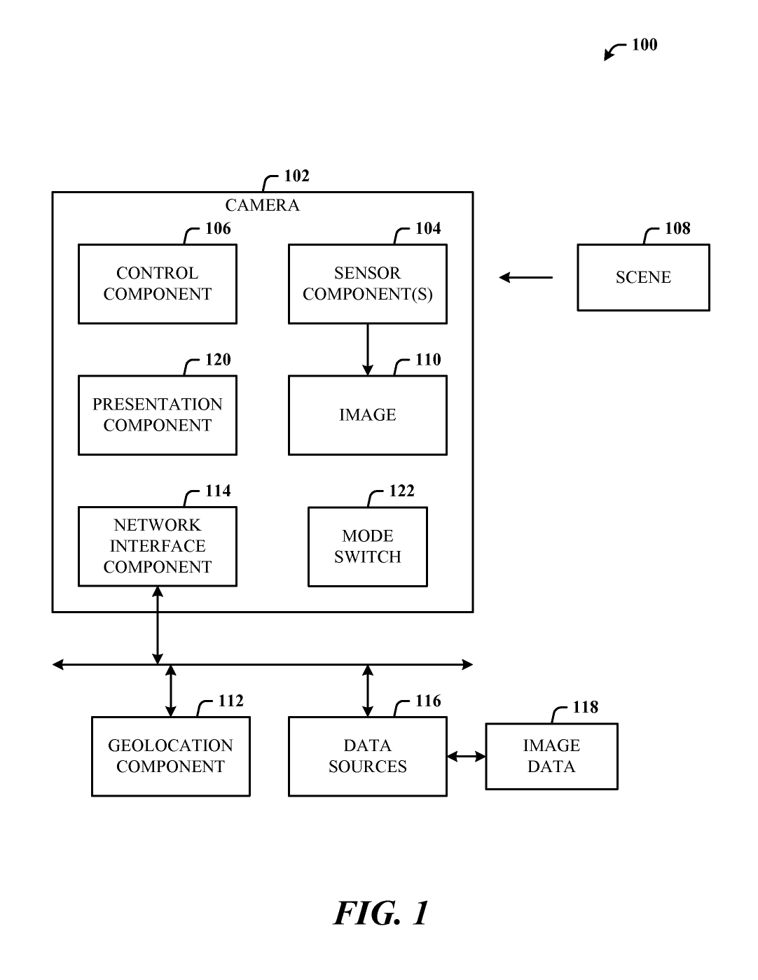

FIG. 1 illustrates a photographic system 100 in accordance with the disclosed architecture. The system 100 includes a camera 102 having one or more sensor components 104 and a control component 106 for interacting with a scene 108 to be captured as an image 110. A geolocation component 112 associated with the camera 102 determines geographic location of the camera 102. A network interface component 114 (wired and/or wireless) associated with the camera 102 facilitates access to data sources 116 having image data 118 related to the geographic location. A presentation component 120 indicates an adjustment to a sensor based on the image data 118.

The image data 118 can be a photo previously taken relative to the scene 108. The image data 118 can include an image previously taken of the scene 108, and metadata associated with camera settings employed by other photographers to take the image 110. The camera 102 queries a web service (e.g., one of the data sources 116) via the network interface component 114 for images taken of the scene 108 and the presentation component 120 presents the images.

The geolocation component 112, the network interface component 114, and the presentation component 120 can all be part of the camera 102, or as indicated, the geolocation component 112 can be external, as a separate device or in another system to which the camera interfaces (e.g., a computing device).

The control component 106 can restrict adjustment of a sensor (of the one or more sensor components 104) based on the image data 118, where the adjustment exceeds the hardware and/or software capabilities of the camera 102. The control component 106 can also filter the image data 118 based on capabilities of the camera 102. The image data 118 can include cues related to aperture setting, lighting setting, time of day that the image was captured, time of year, season, heading of camera 102, zoom settings, and centering settings, to name just a few.

As cameras become better equipped with improved and new sensory functions such geolocation subsystems (e.g., GPS-global positioning system), a compass, an altimeter, and wireless connectivity such as cellular, wi-fi, and short-range wireless communications such as Bluetooth, these and other camera system and interfacing system capabilities can be exploited for use by the user.

Oftentimes, users who are not professional photographers are frustrated using some or all available features of a camera in order to simply shoot a scene and how to take the shots especially when at a new location. Users can easily become overwhelmed by the unfamiliar sceneries.

There is a huge volume of quality photos taken at worldwide locations that are now available on the Internet from online services and social networks as taken by other users, for example. With increasing frequency, these photos are becoming geo-tagged, and searchable via geolocation coordinates (e.g., latitude and longitude). Thus, the disclosed architecture utilizes this online data in the form of photos and other related data to help users decide what to shoot and provide other valuable information for setting up the shots.

As previously depicted, the geolocation component 112 is external to the camera 102, as employed in a specific geolocation device, or as part of a computer, for example. However, alternatively, the geolocation component 112 can be designed internal as part of the camera 102.

The following description assumes that the camera 102 is equipped with GPS and wireless Internet access. Using the GPS, the camera 102 can determine its present latitude and longitude. The camera 102 then queries a web service for photos taken at the same location, and displays the photos to the user via the presentation component 120 (e.g., a display). If the user likes a particular photo, the user can select the photo interacting with display options or other selection capabilities.

The selected photo can also be associated with photo metadata that indicates where the photo was taken, date, season, camera type and settings, etc. The camera 102 then uses the metadata to indicate to the user the time of the day the photo was taken (in case that the user wants to have similar lighting conditions) and defaults to some or all of the metadata settings such as aperture, shutter speed, and ISO, for example. Other cues used may include time of the year/season, heading of the camera, zoom settings and centering. In this way, the user only needs to point the camera at the same scene, and shoot.

The architecture also provides fallback options via the control component 106 in a scenario where the photo (as part of the image data 118) previously taken of the scene 108 cannot be duplicated, such as if the target “professional” photo uses a zoom or aperture setting no obtainable by the capabilities of the user camera 102, or if the user cannot achieve the same vantage point or time of day, for example. Further, the user camera 102 can also restrict the available choices to, for example, photos taken in the same season and approximately the same time of day.

The disclosed architecture provides the opportunity to use the camera 102 as a training device, in that, teaching photographer can offer virtual training tours by setting up an online site with a sequence of photographs of various locations. The teacher can restrict the queried photos to those utilized as part of the virtual tour. Thus, the student user interacts with a training session that employs a consistent and complete lesson on photography as provided by the teacher and at a date chosen by the teacher.

The camera 102 can also include a mode switch 122 that allows the user to switch (manually or automatically) the camera 102 between modes that include an unassisted mode (normal or default), assisted mode (optional), and a training mode. This can be configurable using manual switches, for example, and/or an onboard software configuration subsystem.

In the event of network failure or inability of the camera 102 to connect to external sources, the camera 102 can use an optional stored onboard collection of images from popular photo sites or default to the unassisted mode.

Further, the system 100 provides the capability to pre-fetch images (or image “feature points”) and metadata from popular spots when the user shows a predictable behavior (e.g., visited other tourist sites in the area), or the user's intentions to tour a site (e.g., the Great Wall of China) is evident from other side information (e.g., tour bookings, explicit input from the user, etc.), and then to start downloading and cache image data from the Great Wall while the user is headed to the site.

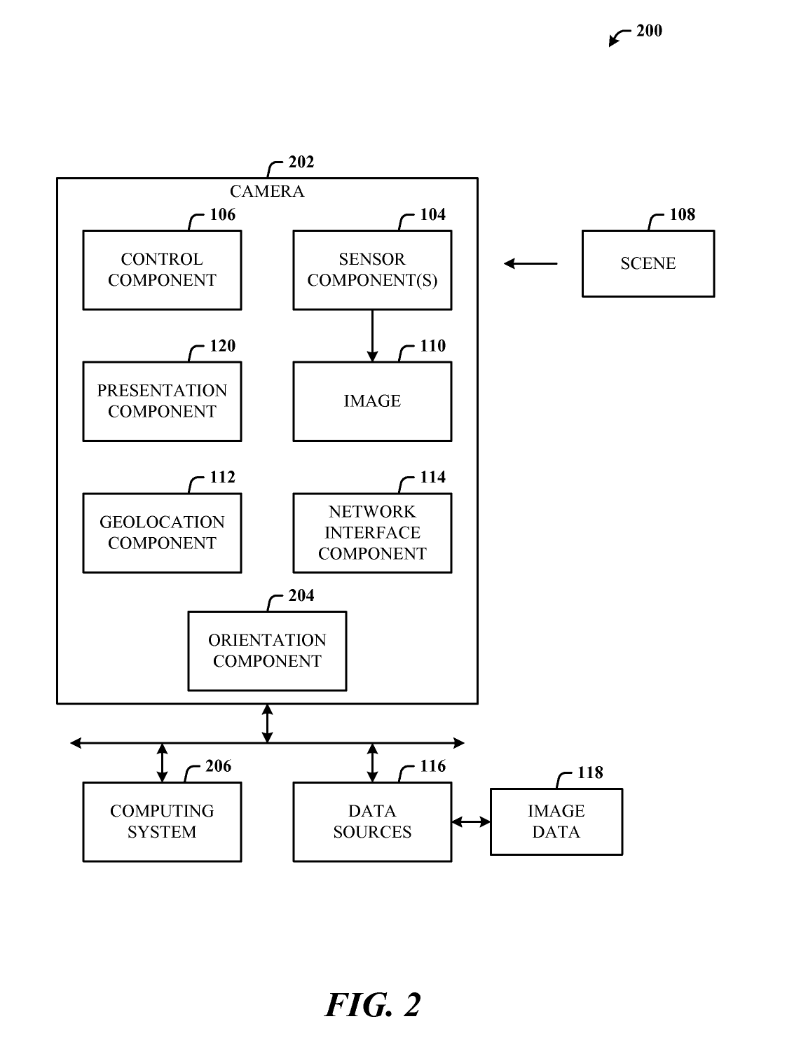

The heading or direction of the camera (as directed to the scene 108) cannot be judged solely with geolocation coordinates. FIG. 2 illustrates a system 200 where a camera 202 employs an orientation component 204 to determine and track heading and an angular offset from a plane of view to the scene 108. Here, the camera 202 also includes the geolocation component 112, as well as the other components of the camera 102 of FIG. 1.

To estimate the heading, the orientation component 204 can include an accelerometer (or other sensor device that provides similar data), for example, to estimate the angle of tilt from the ground (plane), and a compass to estimate the angular offset on the plane. If this orientation capability is lacking on the camera 102 or via other devices, suitable text cues can be inserted into the training session, such as “Point the camera in the Southern direction of the Wall”, for example.

In a more advanced embodiment, the above techniques can be combined with 3D photo technologies to assist the user in orienting the shot and judge the distance from the main object of interest in the scene 108. Image processing technologies can be employed to partially solve the heading problem by matching the just-taken photo against a database of photos (of the image data 118) previously taken of the scene to determine heading. Moreover, image processing techniques can be employed to align (e.g., by zoom) the image (from the viewfinder) with the photo obtained from the data sources 116 once the user has pointed the camera in the same general direction.

The camera 202 can interface to an external computing system 206 (e.g., GPS device, cell phone, PDA (personal digital assistant)) to obtain augmented capabilities not obtainable via the camera 202. For example, the computing system 206 may provide image matching capabilities that may not be obtainable for the camera 202. Similarly, the computing system 206 can provided additional control capabilities not provided by the onboard control component 106, or additional display capabilities not provided by the onboard presentation component 102, and so on.

Alternatively, the camera 202 may have enhanced capabilities that can only be more richly experienced by interfacing to the computing system 206, such as detailed image matching methods, more robust display of image metadata, web sources information, interaction with the teacher during a live online session, etc.

Put another way, the photographic system comprises a camera having one or more sensor components and a control component for interacting with a scene to be captured as an image, a geolocation component of the camera associated with the camera for determining geographic location of the camera, an orientation component of the camera that determines heading of the camera relative to the scene and angular offset of the camera relative to a plane of the scene, a network interface component of the camera associated with the camera that facilitates access to data sources having image data related to the geographic location, and a presentation component of the camera that indicates an adjustment to a sensor based on the image data.

The image data includes an image previously taken of the scene, and metadata that includes camera settings employed to take the image. The camera obtains an onboard collection of images associated with the scene and indicates the adjustment based on the onboard collection. The camera queries a web service via the network interface component for images taken of the scene and the presentation component presents the images. The control component restricts adjustment of a sensor based on image data that exceeds capabilities of the camera and filters the image data based on capabilities of the camera. Additionally, the control component initiates prefetch of images and image metadata based on predictable behavior of a user of the camera, or user intention to visit a given scene location. The image data includes cues related to at least one of aperture setting, lighting setting, time of day that the image was captured, time of year, season, heading of camera, zoom settings, or centering settings.

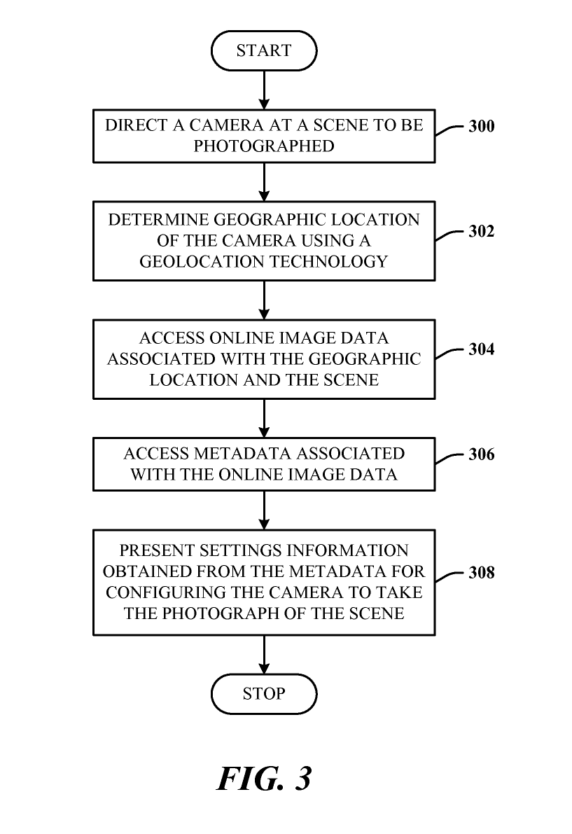

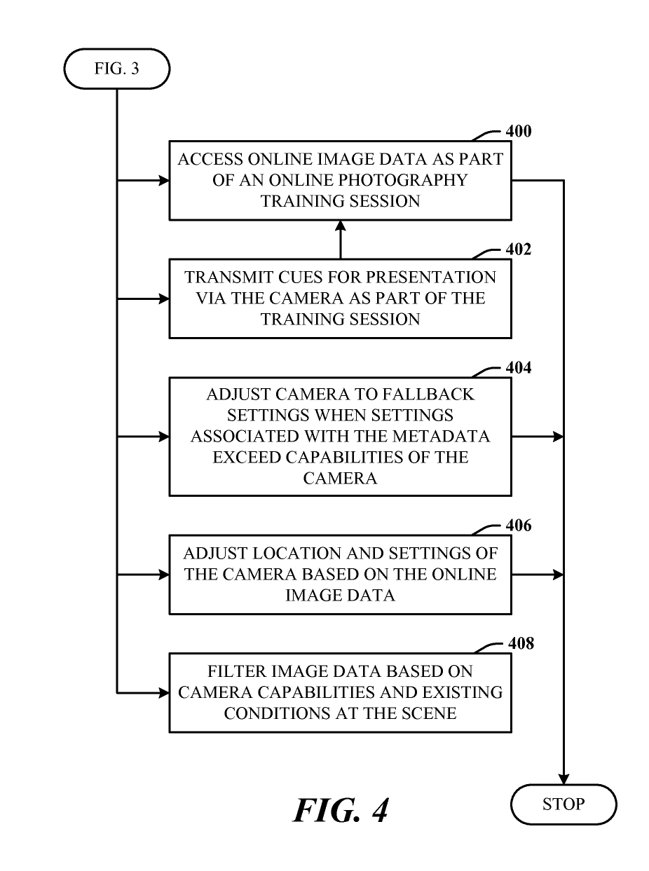

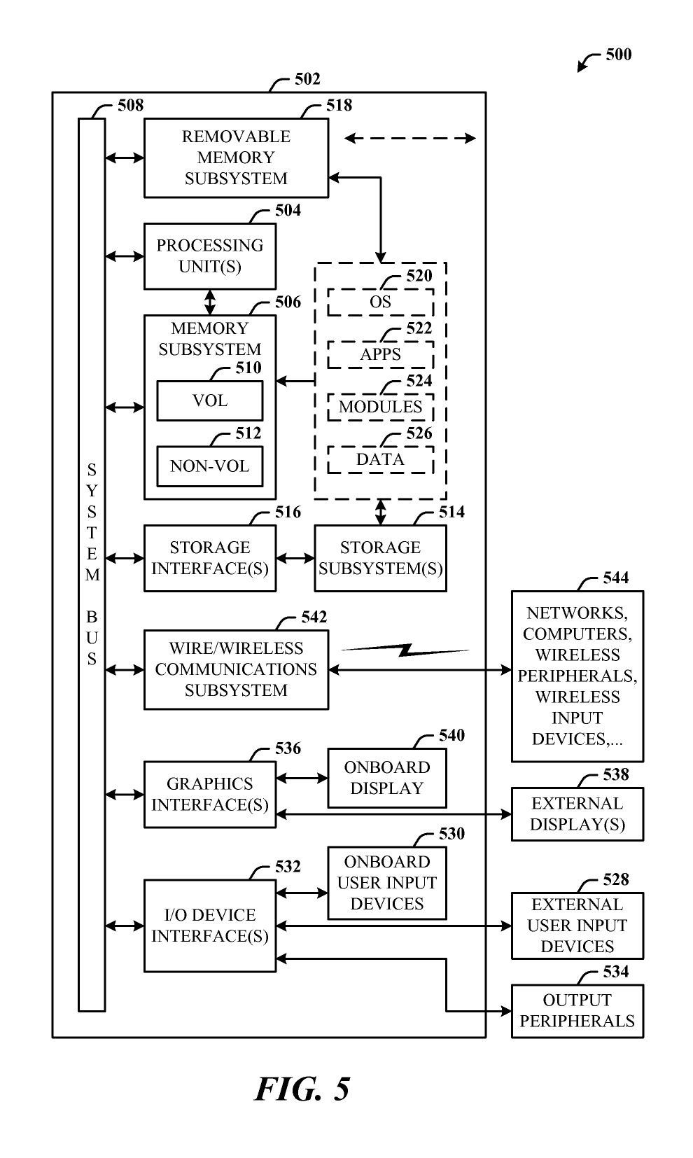

Note that the camera 102 (and 202) can include many of the hardware capabilities and software capabilities described in combination with the computing system 502 in FIG. 5 below, such as memory, network interfaces, graphics for rich presentation and cues, and so on. The software capabilities can include the entities and components of the camera 102 of FIG. 1, the entities and components of the camera 202 of FIG. 2, and portions of the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 3 illustrates a computer-implemented photographic method in accordance with the disclosed architecture. At 300, a camera is directed at a scene to be photographed. At 302, geographic location of the camera is determined using a geolocation technology. At 304, online image data associated with the geographic location and the scene is accessed. At 306, metadata associated with the online image data is accessed. At 308, settings information obtained from the metadata is presented for configuring the camera to take the photograph of the scene.

FIG. 4 illustrates further aspects of the method of FIG. 3. At 400, online image data is accessed as part of an online photography training session. At 402, cues are transmitted for presentation via the camera as part of the training session. At 404, the camera is adjusted to fallback settings when settings associated with the metadata exceed capabilities of the camera. At 406, location and settings of the camera are adjusted based on the online image data. At 408, the image data is filtered based on camera capabilities and existing conditions at the scene.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

Referring now to FIG. 5, there is illustrated a block diagram of a computing system 500 that can interface to the camera in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A photographic system having a processor, comprising:
a camera having one or more sensor components and a control component for interacting with a scene to be captured as an image;
a geolocation component associated with the camera for determining geographic location of the camera;
a network interface component associated with the camera that facilitates access to data sources having image data related to the geographic location; and
a presentation component that indicates an adjustment to a sensor based on the image data.

2. The system of claim 1, further comprising a mode switch that allows switching of the camera between an assisted mode, an unassisted mode, and a training mode.

3. The system of claim 1, wherein the image data includes an image previously taken of the scene, and metadata associated with camera settings previously employed to take the image.

4. The system of claim 1, wherein the camera queries a web service via the network interface component for images taken of the scene and the presentation component presents the images.

5. The system of claim 1, wherein the geolocation component, the network interface component, and the presentation component are part of the camera.

6. The system of claim 1, wherein the control component restricts adjustment of a sensor based on image data that exceeds capabilities of the camera.

7. The system of claim 1, wherein the control component filters the image data based on capabilities of the camera.

8. The system of claim 1, wherein the image data includes cues related to aperture setting, lighting setting, time of day that the image was captured, time of year, season, heading of camera, zoom settings, and centering settings.

9. The system of claim 1, further comprising an orientation component that determines heading of the camera relative to the scene and angular offset of the camera relative to a plane of the scene.

10. A photographic system having a processor, comprising:
a camera having one or more sensor components and a control component for interacting with a scene to be captured as an image;
a geolocation component of the camera associated with the camera for determining geographic location of the camera;
an orientation component of the camera that determines heading of the camera relative to the scene and angular offset of the camera relative to a plane of the scene;
a network interface component of the camera associated with the camera that facilitates access to data sources having image data related to the geographic location; and
a presentation component of the camera that indicates an adjustment to a sensor based on the image data.

11. The system of claim 10, wherein the camera obtains an onboard collection of images associated with the scene and indicates the adjustment based on the onboard collection.

12. The system of claim 10, wherein the camera queries a web service via the network interface component for images taken of the scene and the presentation component presents the images.

13. The system of claim 10, wherein the control component initiates prefetch of images and image metadata based on predictable behavior of a user of the camera, or user intention to visit a given scene location.

14. The system of claim 10, wherein the image data includes cues related to at least one of aperture setting, lighting setting, time of day that the image was captured, time of year, season, heading of camera, zoom settings, or centering settings.

15. A computer-implemented photography method executable via a processor, comprising:
directing a camera at a scene to be photographed;
determining geographic location of the camera using a geolocation technology;
accessing online image data associated with the geographic location and the scene;
accessing metadata associated with the online image data; and
presenting settings information obtained from the metadata for configuring the camera to take the photograph of the scene.

16. The method of claim 15, further comprising accessing the online image data as part of an online photography training session.

17. The method of claim 16, further comprising transmitting cues for presentation via the camera as part of the training session.

18. The method of claim 15, further comprising adjusting the camera to fallback settings when settings associated with the metadata exceed capabilities of the camera.

19. The method of claim 15, further comprising adjusting location and settings of the camera based on the online image data.

20. The method of claim 15, further comprising filtering the image data based on camera capabilities and existing conditions at the scene.
